(19) United States
(12) Patent Application Publication
(10) Pub. No.: US 2013/0050104 A1
(43) Pub. Date: Feb. 28, 2013

(54) TOUCH PANEL

(71) Applicants: Ji Soo Lee, Gyunggi-do (KR); Youn Soo Kim, Seoul (KR); Ho Joon Park, Seoul (KR)

(72) Inventors: Ji Soo Lee, Gyunggi-do (KR); Youn Soo Kim, Seoul (KR); Ho Joon Park, Seoul (KR)

(73) Assignee: SAMSUNG ELECTRO-MECHANICS CO., LTD., Gyunggi-do (KR)

(21) Appl. No.: 13/324,561

(22) Filed: Dec. 13, 2011

(30) Foreign Application Priority Data
Aug. 30, 2011 (KR) 1020110087341

(51) Int. Cl. G06F 3/041

(52) U.S. Cl. 345/173

(57) ABSTRACT

Disclosed herein is a touch panel, including: a transparent substrate divided into an active area and a bezel area surrounding the active area; sensing electrodes formed in the active area; electrode wirings formed in the bezel area and connected to the sensing electrodes; and a window provided outside the transparent substrate and having a groove recessed correspondingly to a boundary between the active area and the bezel area. According to the present invention, the groove is formed on the window to minimize capacitance between the electrode wiring and the input unit, with the result that the touched coordinates can be accurately sensed by the sensing electrode.

### CROSS REFERENCE TO RELATED APPLICATION

This application claims the benefit of Korean Patent Application No. 10-2011-00087341, filed on Aug. 30, 2011, entitled “Touch Panel”, which is hereby incorporated by reference in its entirety into this application.

### BACKGROUND OF THE INVENTION

1. Technical Field

The present invention relates to a touch panel.

2. Description of the Related Art

With the development of computers using digital technology, devices assisting the computers have also been developed, and personal computers, portable transmitters and other personal information processors execute processing of text and graphics using a variety of input devices such as a keyboard, a mouse and so on.

While the rapid advancement of an information-oriented society has been widening the use of computers more and more, there have been occurring the problems of it being difficult to efficiently operate products using only the keyboard and mouse as being currently responsible for the input device function. Thus, the demand for a device that is simple, has minimal malfunction, and has the capability to easily input information is increasing.

Furthermore, current techniques for input devices exceed the level of fulfilling general functions and thus are progressing towards high reliability, durability, innovation, designing and manufacturing related techniques, etc. To this end, a touch panel has been developed as an input device capable of inputting information such as text and graphics, etc.

The touch panel is mounted on the display surface of an image display device such as an electronic organizer, a flat panel display including a liquid crystal display (LCD), a plasma display panel (PDP), an electroluminescence (El) element, or the like, or a cathode ray tube (CRT), so that a user selects desired information while viewing the image display device.

The touch panel is classifiable as a resistive type, a capacitive type, an electro-magnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, a capacitive type touch panel is prevalently used in a broad range of fields currently.

FIG. 1 is a cross-sectional view of a capacitive type touch panel according to the prior art. Problems of the prior art will be described with reference to FIG. 1.

As shown in FIG. 1, a capacitive type touch panel 10 consists of a transparent substrate 1, a window 2 provided outside the transparent substrate 1, a sensing electrode 3 formed on the transparent substrate 1, and an electrode wiring 4 connected to the sensing electrode 3. When a user touches the window 2 by using an input unit 5 such as a finger or the like, capacitance C₁ is generated between the sensing electrode 3 and the input unit 5 and thus touched coordinates are sensed. However, when the capacitive type touch panel 10 according to the prior art is touched, capacitance C₂ is also generated between the electrode wiring 4 and the input unit 5 as well as the capacitance C₁ is generated between the sensing electrode 3 and the input unit 5, with the result that the touched coordinates can not be accurately sensed.

Furthermore, noise generated at the electrode wiring 4 affects the sensing electrode 3 (particularly, the sensing electrode 3 adjacent to the electrode wiring 4), thereby deteriorating sensitivity of the touch panel 10.

### SUMMARY OF THE INVENTION

The present invention has been made in an effort to provide a touch panel capable of preventing deterioration in sensitivity due to effect of electrode wirings, by forming a groove on a window or an adhesive layer.

According to a preferred embodiment of the present invention, there is provided a touch panel, including: a transparent substrate divided into an active area and a bezel area surrounding the active area; sensing electrodes formed in the active area; electrode wirings formed in the bezel area and connected to the sensing electrodes; and a window provided outside the transparent substrate and having a groove recessed correspondingly to a boundary between the active area and the bezel area.

The groove may have an air gap formed therein.

The sensing electrodes may be patterned and the groove may be extended correspondingly to a gap between adjacent sensing electrodes among the sensing electrodes.

The touch panel may further include an adhesive layer provided between the transparent substrate and the window.

The sensing electrode and the electrode wiring may be formed in one body.

According to another preferred embodiment of the present invention, there is provided a touch panel, including: a transparent substrate divided into an active area and a bezel area surrounding the active area; sensing electrodes formed in the active area; electrode wirings formed in the bezel area and connected to the sensing electrodes; a window provided outside the transparent substrate; and an adhesive layer provided between the transparent substrate and the window, and having a hole penetrated correspondingly to a boundary between the active area and the bezel area.

The hole may have an air gap formed therein.

The sensing electrodes may be patterned and the hole may be extended correspondingly to a gap between adjacent sensing electrodes among the sensing electrodes.

The sensing electrode and the electrode wiring may be formed in one body.

### BRIEF DESCRIPTION OF THE DRAWINGS

FIG. 1 is a cross-sectional view of a capacitive type touch panel according to the prior art;

FIGS. 2A and 2B are an exploded perspective view and a plan view of a touch panel according to a first preferred embodiment of the present invention;

FIG. 3 is a cross section taken along the line A-A′ of the touch panel shown in FIG. 2B;

FIGS. 4A and 4B are an exploded perspective view and a plan view of a modification example of the touch panel according to the first preferred embodiment of the present invention;

FIG. 5 is a cross section taken along the line B-B′ of the touch panel shown in FIG. 4B;

FIGS. 6A and 6B are an exploded perspective view and a plan view of a touch panel according to a second preferred embodiment of the present invention;

FIG. 7 is a cross section taken along the line C-C′ of the touch panel shown in FIG. 6B;

FIGS. 8A and 8B are an exploded perspective view and a plan view of a modification example of the touch panel according to the second preferred embodiment of the present invention; and

FIG. 9 is a cross section taken along the line D-D′ of the touch panel shown in FIG. 8B.

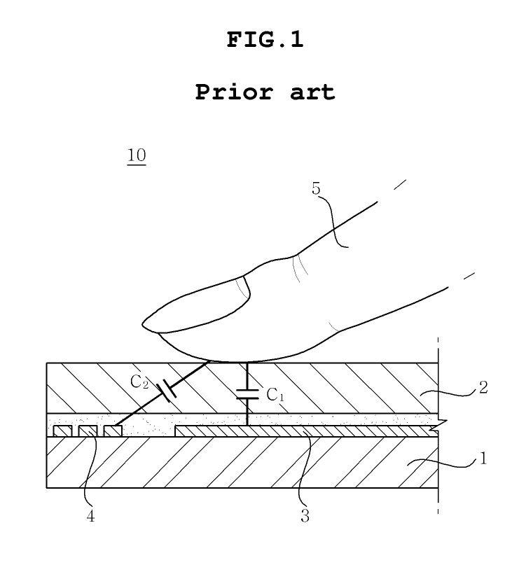

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, preferred embodiments of the present invention will be described in detail with reference to the accompanying drawings.

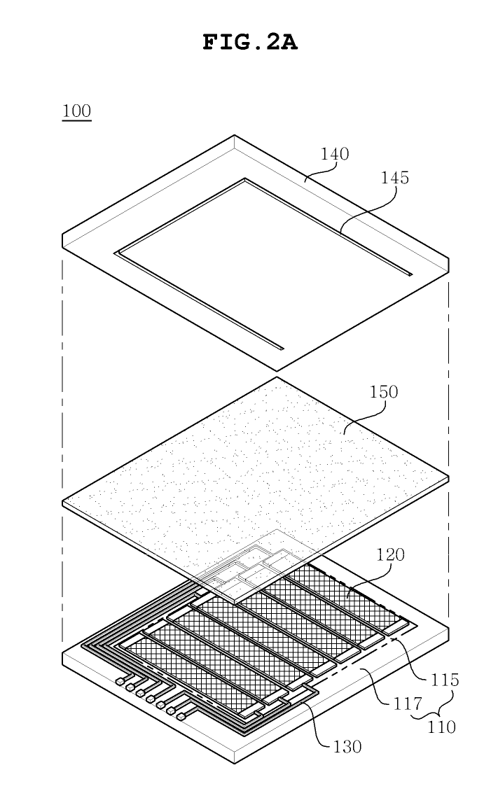

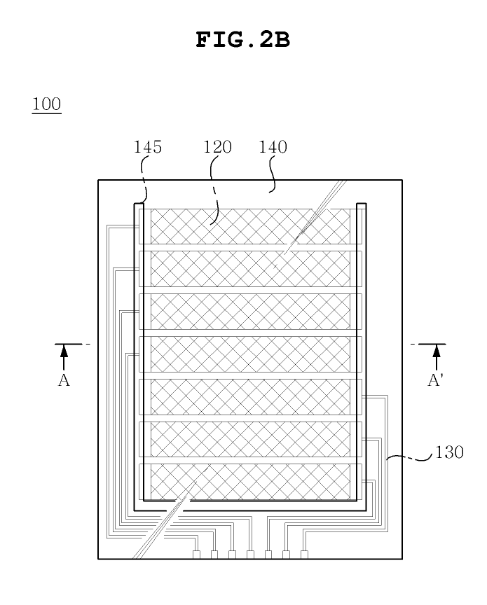

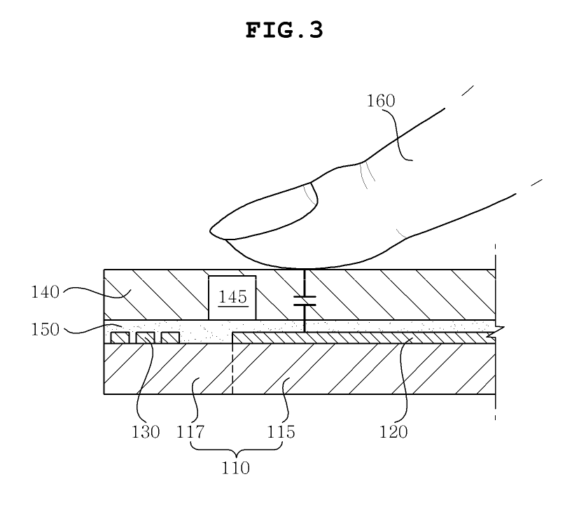

FIGS. 2A and 2B are an exploded perspective view and a plan view of a touch panel according to a first preferred embodiment of the present invention, and FIG. 3 is a cross section taken along the line A-A′ of the touch panel shown in FIG. 2B.

As shown in FIGS. 2A to 3, a touch panel 100 according to the present preferred embodiment includes: a transparent substrate 110 divided into an active area 115 and a bezel area 117 surrounding the active area 115; sensing electrodes 120 formed in the active area 115; electrode wirings 130 formed in the bezel area 117 and connected to the sensing electrodes 120; and a window 140 provided outside the transparent substrate 110, and having a groove 145 recessed correspondingly to a boundary between the active area 115 and the bezel area 117.

The transparent substrate 110 functions to provide an area where the sensing electrodes 120 and the wiring electrodes 130 are to be formed. Here, the transparent substrate 110 is divided into the active area 115 and the bezel area 117. The active area is an area where the sensing electrodes 120 are to be formed in order to allow the sensing electrodes to recognize touch by the input unit 160, and provided at the center on the transparent substrate 110. The bezel area 117 is an area where the electrode wirings 130 connected to the sensing electrodes 120 are to be formed, and provided outside the active area 115 to surround the active area 115. Here, the transparent substrate 110 needs to have durability capable of supporting the sensing electrodes 120 and the wiring electrodes 130 and transparency through which a user can recognize an image provided by an image display device. In consideration of the above-described durability and transparency, the transparent substrate 110 is preferably formed of polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or tempered glass, and so on, but is not particularly limited thereto.

The sensing electrode 120 functions to sense a variation in capacitance at the time of touch by the input unit 160 to allow a controller to recognize touched coordinates. The sensing electrode 120 is formed in the active region 115 of the transparent substrate 110. The sensing electrodes 120 are formed within the active area 115. Here, the sensing electrode 120 may be formed in a mesh pattern, by using copper (Cu), aluminum (Al), gold (Au), silver (Ag), titanium (Ti), palladium (Pd), chrome (Cr), or a combination thereof. Among them, the sensing electrode 120 is preferably formed by using copper (Cu), aluminum (Al), gold (Au), or silver (Ag), but a material for the sensing electrode 120 is not limited thereto. Any metal that can have high electric conductivity and high processability may be used for the sensing electrode 120. Meanwhile, when the sensing electrode 120 is formed by using copper (Cu), it is preferable to perform black oxide treatment on a surface of the sensing electrode 120. The black oxide treatment is a process by which the surface of the sensing electrode 120 is oxidized to precipitate Cu₂O or CuO. As such, the black oxide treatment is performed on the surface of the sensing electrode 120, thereby preventing light from being reflected to the sensing electrode 120, with the result that visibility of the touch panel 100 can be improved. The sensing electrode 120 may be formed by using indium thin oxide (ITO) or a conductive polymer, other than the above-described metals. Here, the conductive polymer may include poly-3, 4-ethylenedioxythiophene/polystyrenesulfonate (PEDOT/PSS), polyaniline, polyacetylene, polyphenylenevinylene, or the like.

Meanwhile, the sensing electrode 120 is formed in a bar-type pattern in the drawing (see, FIGS. 2A and 2B), but not limited thereto. The sensing electrode 120 may be formed in any pattern known to the art, such as, a diamond-type pattern, a square-type pattern, a triangle-type pattern, a circle-type pattern, or the like.

The electrode wirings 130 are connected to the sensing electrodes 120, and thus, function to receive electric signals from the sensing electrodes 120. The electrode wirings 130 are formed in the bezel area 117 of the transparent substrate 110. Here, the electrode wiring 130 is preferably formed of a high-electric conductivity material, such as silver (Ag), but not limited thereto. The electrode wiring 130 may be formed by using copper (Cu), gold (Au), aluminum (Al), or the like. Furthermore, according to the need, the electrode wiring 130 and the sensing electrode 120 may be formed in one body, with the result that a manufacturing process of the touch panel 100 can be simplified and a lead time can be shortened. Further, since the sensing electrode 120 and the electrode wiring 130 are formed in one body when the sensing electrode 120 is formed, an attaching process between the electrode wiring 130 and the sensing electrode 120 can be omitted, thereby previously preventing problems, such as, height differences or defective attachment, which occurs between the sensing electrode 120 and the electrode wiring 130.

The window 140 is provided outside the transparent substrate 110, so as to function to receive touch by the input unit 160 (see, FIG. 3). Here, a material for the window 140 is not particularly limited, but the window 140 is preferably formed of glass, tempered glass, or the like. Meanwhile, a groove 145 is formed on the window 140 correspondingly to a boundary between the active area 115 and the bezel area 117 of the transparent substrate 110. Here, the groove 145 is formed to have a shape in which the window 140 is partially recessed at a predetermined depth in a thickness direction thereof, and formed correspondingly to the boundary between the active area 115 and the bezel area 117. Therefore, the groove 145 is disposed between the sensing electrodes 120 formed in the active area 115 and the electrode wirings 130 formed in the bezel area. In addition, air is provided in the groove 145 to form an air gap. As such, the groove 145 is disposed between the sensing electrodes 120 and the electrode wirings 130, and provided with air having a very low dielectric constant of 1.0005. Therefore, even though an outside of the active area 115 (a region in the vicinity of the electrode wirings 130) is touched by the input unit 160, capacitance can be minimized between the electrode wirings 130 and the input unit 160. Therefore, the capacitance can be prevented to be distorted between the sensing electrodes 120 and the input unit 160, and finally sensitivity of the touch panel 100 can be improved.

In addition, the groove 145 is formed on the window 140, thereby preventing noise generated at the electrode wirings 130 from affecting the sensing electrodes 120.

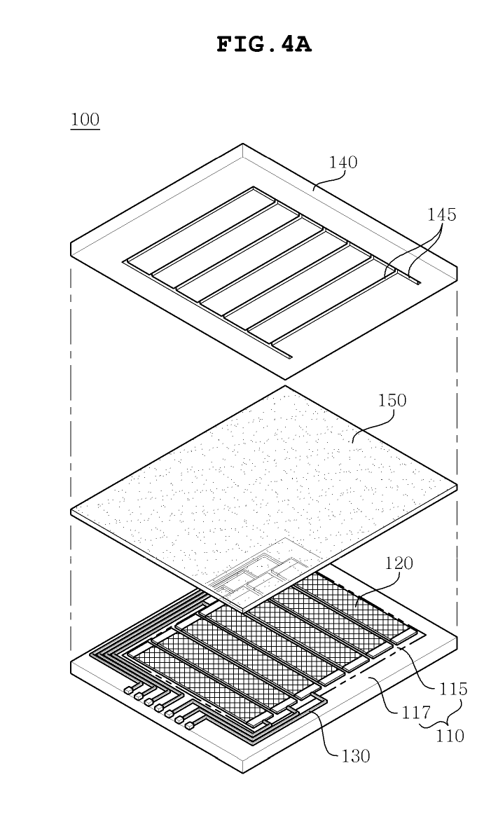

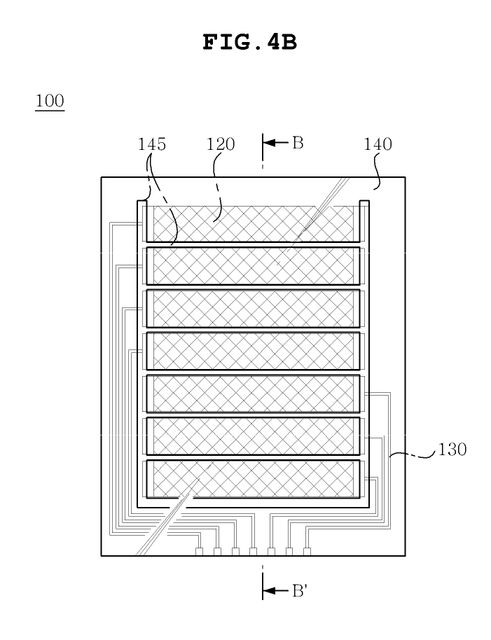

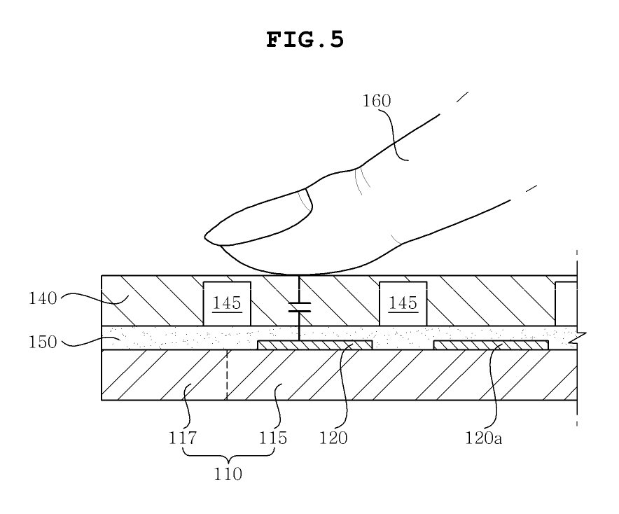

FIGS. 4A and 4B are an exploded perspective view and a plan view of a modified example of touch panel according to the first preferred embodiment of the present invention, and FIG. 5 is a cross section taken along the line B-B′ of the touch panel shown in FIG. 4B.

As shown in FIGS. 4A to 5, the groove 145 of the window 140 may be extended correspondingly to patterns of the sensing electrodes 120. Specifically, the groove 145 is preferably extended correspondingly a gap between adjacent sensing electrodes 120 among the patterned sensing electrodes 120. For example, when the sensing electrode 120 is formed in a bar-type pattern (see, FIGS. 4A and 4B), the groove 145 is extended in a shape having a plurality of horizontal lines correspondingly to the gaps between adjacent bar-type sensing electrodes 120. As such, the groove 145 is disposed between the adjacent sensing electrodes 120 and 120a and provided with air having a low dielectric constant (see, FIG. 5). Therefore, when the active area 115 is touched by the input unit 160, the capacitance is sufficiently generated between the sensing electrode 120, which corresponds to the touched part, and the input unit 160, but hardly generated between the neighboring sensing electrode 120a, which is adjacent to the touched part, and the input unit 160, with the result that interference of the neighboring sensing electrodes 120a can be minimized.

In addition, a method of forming the groove 145 on the window 140 is not particularly limited, but the groove 145 may be formed by mechanical removal through dicing saw or chemical etching using hydrofluoric acid.

Meanwhile, an adhesive layer 150 may be provided between the transparent substrate 110 and the window 140. In other words, the window 140 and the transparent substrate 110 may be attached to each other by using the adhesive layer 150. Here, a transparent material is preferably used for the adhesive layer 150, and for example, an optical clear adhesive (OCA) may be used.

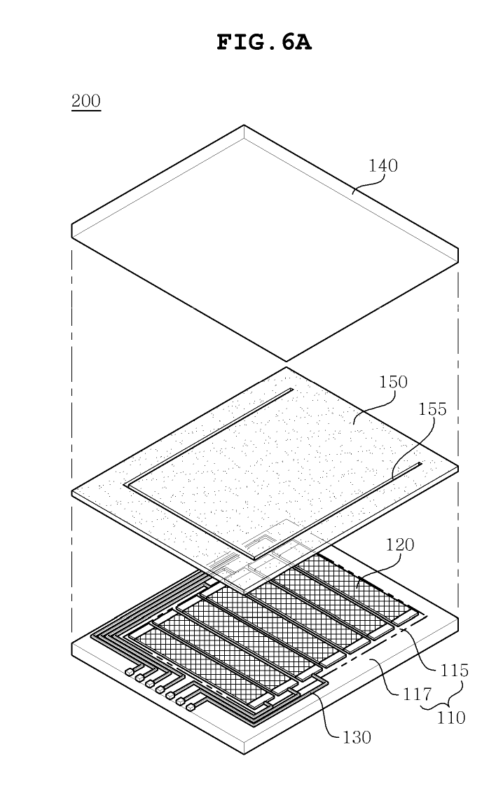

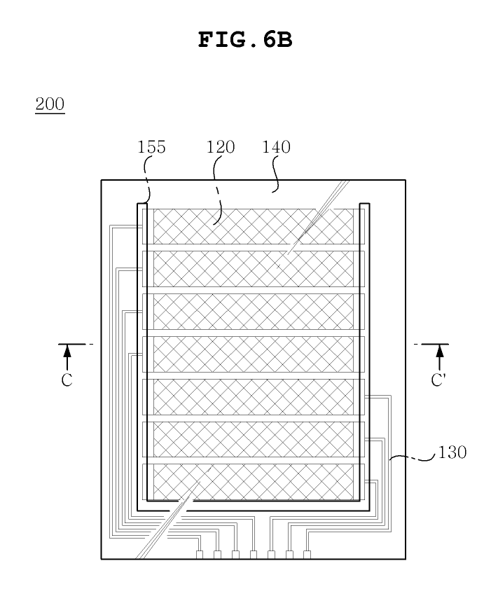

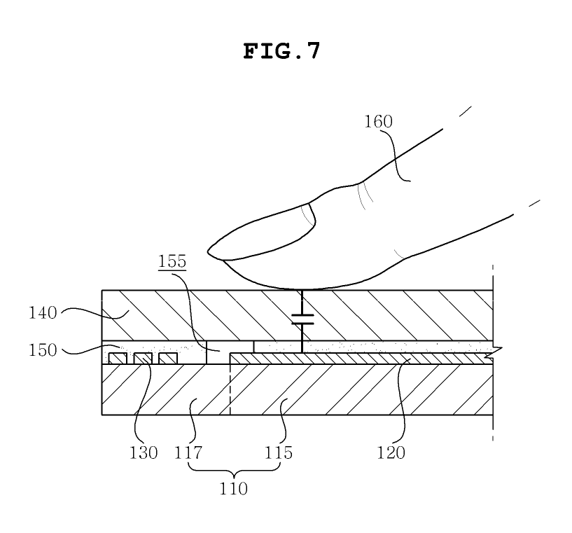

FIGS. 6A and 6B are an exploded perspective view and a plan view of a touch panel according to a second preferred embodiment of the present invention, and FIG. 7 is a cross section taken along the line C-C′ of the touch panel shown in FIG. 6B.

As shown in FIGS. 6 and 7, the most significant difference between the touch panel 200 according to the present preferred embodiment and the touch panel 100 according to the first preferred embodiment is a position of the grooves 145 and holes 155. In other words, while the groove 145 is formed on the window 140 in the touch panel 100 according to the first preferred embodiment of the present invention, the hole 155 is formed in the adhesive layer 150 in the touch panel 200 according to the present preferred embodiment. Therefore, the present preferred embodiment will be described based on the position at which the hole 155 is formed, and descriptions overlapping the first preferred embodiment will be omitted.

In the touch panel 200 according to the present preferred embodiment, sensing electrodes 120 are formed in an active area 115 of a transparent substrate 110 and electrode wirings 130 are formed in a bezel area 117 of the transparent substrate 110. A window 140 is provided outside the transparent substrate 110. In addition, an adhesive layer 150 is provided between the transparent substrate 110 and the window 140 to attach the transparent substrate 110 and the window 140 to each other. Here, a hole 155 is formed in the adhesive layer 150 correspondingly to a boundary between the active area 115 and the bezel area 117. Here, the hole 155 is formed such that it penetrates the adhesive layer 150 in a thickness direction thereof, and formed correspondingly to the boundary between the active area 115 and the bezel area 117. Therefore, the hole 155 is disposed between the sensing electrodes 120 formed in the active area 115 and the electrode wirings 130 formed in the bezel area 117 (see, FIG. 7). In addition, air is provided in the hole 155 to form an air gap. As such, the hole 155 is disposed between the sensing electrodes 120 and the electrode wirings 130, and provided with air having a very low dielectric constant of 1.0005. Therefore, even though an outside portion of the active area 115 (a region in the vicinity of the electrode wirings 130) is touched by the input unit 160, capacitance can be minimized between the electrode wirings 130 and the input unit 160. Therefore, the capacitance can be prevented to be distorted between the sensing electrodes 120 and the input unit 160, and finally sensitivity of the touch panel 200 can be improved.

In addition, the hole 155 is formed in the adhesive layer 150, thereby preventing noise generated by the electrode wirings 130 from affecting the sensing electrodes 120.

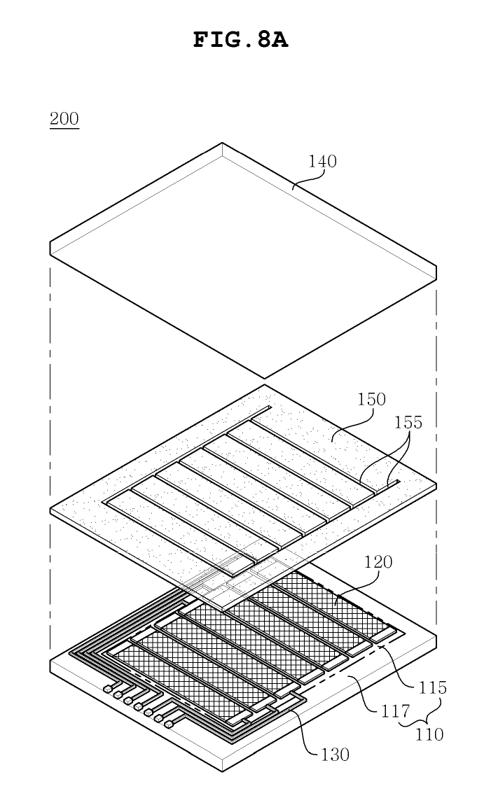

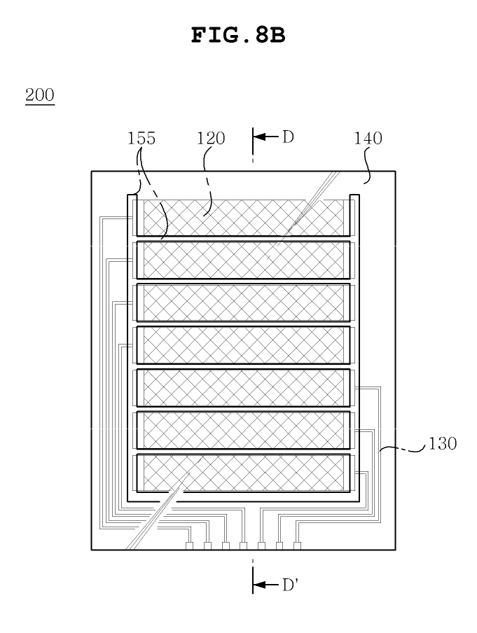

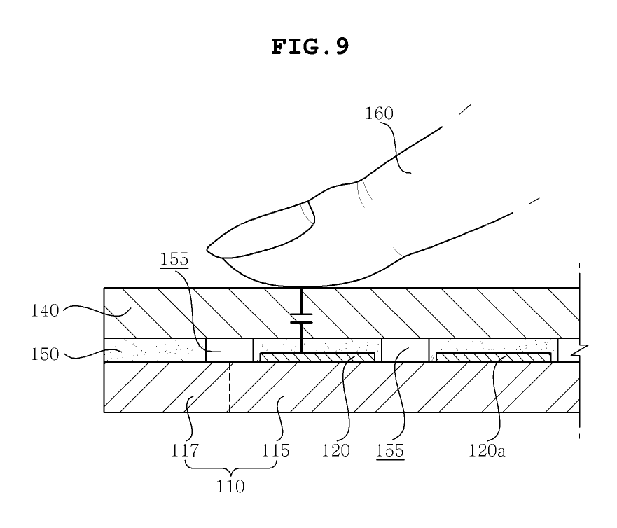

FIGS. 8A and 8B are an exploded perspective view and a plan view of a modified example of touch panel according to the second preferred embodiment of the present invention, and FIG. 9 is a cross section taken along the line D-D′ of the touch panel shown in FIG. 8B.

As shown in FIGS. 8A to 9, the hole 155 of the adhesive layer 150 may be extended correspondingly to patterns of the sensing electrodes 120. Specifically, the hole 155 is preferably extended correspondingly to a gap between adjacent sensing electrodes 120 among the patterned sensing electrodes 120. For example, when the sensing electrode 120 is formed in a bar-type pattern (see, FIGS. 8A and 8B), the hole 155 is extended in a shape having a plurality of horizontal lines correspondingly to the gaps between adjacent bar-type sensing electrodes 120. As such, the hole 155 is disposed between the adjacent sensing electrodes 120 and 120a and provided with air having a low dielectric constant (see, FIG. 9). Therefore, when the active area 115 is touched by the input unit 160, the capacitance is sufficiently generated between the sensing electrode 120, which corresponds to the touched part, and the input unit 160, but hardly generated between the neighboring sensing electrode 120a, which is adjacent to the touched part, and the input unit 160, with the result that interference of the neighboring sensing electrodes 120a can be minimized.

Here, a transparent material is preferably used for the adhesive layer 150, and for example, an optical clear adhesive (OCA) may be used.

According to the present invention, the groove is formed on the window or the hole is formed in the adhesive layer to minimize capacitance between the electrode wiring and the input unit, with the result that the touched coordinates can be sensed by the sensing electrode.

In addition, according to the present invention, the groove is formed on the window or the hole is formed in the adhesive layer to prevent noise generated at the electrode wiring from affecting adjacent sensing electrodes, thereby preventing deterioration in sensitivity of the touch panel.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch panel, comprising:
a transparent substrate divided into an active area and a bezel area surrounding the active area;
sensing electrodes formed in the active area;
electrode wirings formed in the bezel area and connected to the sensing electrodes; and
a window provided outside the transparent substrate and having a groove recessed correspondingly to a boundary between the active area and the bezel area.

2. The touch panel as set forth in claim 1, wherein the groove has an air gap formed therein.

3. The touch panel as set forth in claim 1, wherein the sensing electrodes are patterned and the groove is extended correspondingly to a gap between adjacent sensing electrodes among the sensing electrodes.

4. The touch panel as set forth in claim 1, further comprising an adhesive layer provided between the transparent substrate and the window.

5. The touch panel as set forth in claim 1, wherein the sensing electrode and the electrode wiring are formed in one body.

6. A touch panel, comprising:
a transparent substrate divided into an active area and a bezel area surrounding the active area;
sensing electrodes formed in the active area;
electrode wirings formed in the bezel area and connected to the sensing electrodes;
a window provided outside the transparent substrate; and
an adhesive layer provided between the transparent substrate and the window, and having a hole penetrated correspondingly to a boundary between the active area and the bezel area.

7. The touch panel as set forth in claim 6, wherein the hole has an air gap formed therein.

8. The touch panel as set forth in claim 6, wherein the sensing electrodes are patterned and the hole is extended correspondingly to a gap between adjacent sensing electrodes among the sensing electrodes.

9. The touch panel as set forth in claim 6, wherein the sensing electrode and the electrode wiring are formed in one body.
